(19) United States
(12) Patent Application Publication
(10) Pub. No.: US 2025/0303547 A1
(43) Pub. Date: Oct. 2, 2025

(54) TRUSS ASSEMBLY TABLE PUCK ASSEMBLY

(71) Applicant: Illinois Tool Works Inc., Glenview, IL (US)

(72) Inventors: Mathew N. Milton, Carrollton, TX (US); Ronald E. Findley, Arlington, TX (US)

(21) Appl. No.: 19/077,771

(22) Filed: Mar. 12, 2025

Related U.S. Application Data
(60) Provisional application No. 63/572,648, filed on Apr. 1, 2024.

(51) Int. Cl. B25H 1/10; B25H 1/02

(52) U.S. Cl. CPC B25H 1/10; B25H 1/02

(57) ABSTRACT

A truss assembly table having a plurality of puck assemblies each including a drive rod having outer threads, a mounting block, a block insert positioned in the mounting block, the block defining an inner first channel extending through the block insert from a first end surface to a second end surface, the inner first channel configured to receive the threaded drive rod such that the block insert is journaled about the drive rod, the block insert including inner threads mated with the outer threads of the drive rod, a puck, and a fastener assembly connecting the puck, the mounting block, and the block insert.

### PRIORITY CLAIM

This application claims priority to and the benefit of U.S. Provisional Patent Application No. 63/572,648, filed Apr. 1, 2024, the entire contents of which are incorporated herein by reference.

### BACKGROUND

Wooden trusses are widely used throughout the construction industry. Wooden trusses are often constructed from conventional dimensional lumber members (such as what is commonly known as: a 2 by 4; a 2 by 6; a 2 by 8; etc.). The wooden members that are used to construct a wooden truss are sometimes called truss members in general with the most common truss member types sometimes called chord members and web members. Such chord members extend longitudinally along the length of the truss and such web members extend transversely to the length of the truss such as along the width of the truss. A wooden truss is often built from numerous wooden truss members and metal connectors. The metal connectors are used to attach the truss members to build the wooden truss. Wooden trusses are often prefabricated in a factory and then shipped to a construction site where the wooden trusses are used to construct part of the structure of a building (such as a house or commercial facility). Buildings constructed with such prefabricated wooden roof trusses are often more economical and faster to construct than buildings constructed with conventional stick framed structures.

Various truss assembly tables have been developed and commercialized. Various truss assembly tables include multiple puck assemblies. Each of the puck assembles includes: (1) a drive rod positioned below the top surface of the table top of the truss assembly table; and (2) a puck positioned above the top surface of the table top of the truss assembly table, extending through a transverse vertically extending opening in the table top, connected at a lower end to a puck mounting block that is movably connected to the drive rod. When the drive rod rotates, the drive rod moves the mounting block that in turn moves the puck transversely relative to the table. One issue with existing truss assembly tables is that dust and other debris can get caught in spaces between the drive rod and the mounting block. This can inhibit the effective operation of puck assembly. The material selection and configuration of the puck assembly contribute to the smooth operation of the puck over time as it moves along the threaded rod and within the vertical slot of the table top.

### SUMMARY

In various embodiments, the present disclosure provides a truss assembly table puck assembly including a puck assembly that includes a drive rod, a mounting block, a block insert, a puck, and a puck fastener assembly. The block insert is insertable into the mounting block and includes inner threads configured to mate with outer threads on the drive rod. In various embodiments, the block insert is bronze and defines tight tolerances between the outer threads of the drive rod and the inner threads of the block insert to limit the dust and other debris between the mounting block and the drive rod. In various embodiments, the present disclosure relates to such a truss assembly table including one or more such truss assembly table puck assemblies. In various embodiments, the present disclosure relates to such a mounting block and a block insert for a truss assembly table puck assembly. In various embodiments, the present disclosure relates to such a mounting block for a truss assembly table puck assembly. In various embodiments, the present disclosure relates to such a block insert for a truss assembly table puck assembly.

Additional features and advantages of the present disclosure are described in, and will be apparent from, the following Detailed Description and the Figures.

### BRIEF DESCRIPTION OF THE FIGURES

FIG. 1 is a fragmentary top perspective view of part of a truss assembly table showing one puck assembly thereof in accordance with one example embodiment of the present disclosure.

FIG. 2 is a fragmentary exploded perspective view of part of the puck assembly of the truss assembly table of FIG. 1.

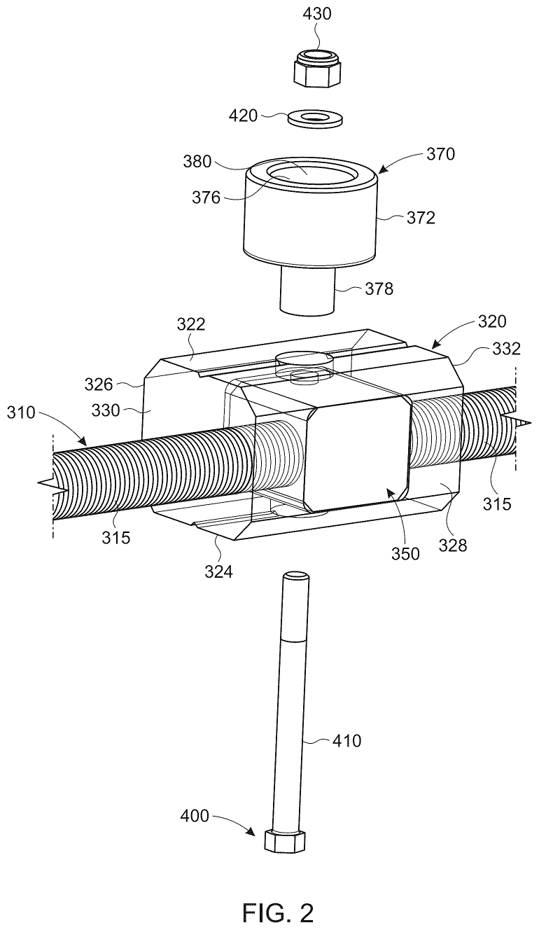

FIG. 3 is a fragmentary partially exploded and partially assembled perspective view of part of the puck assembly of the truss assembly table of FIG. 1.

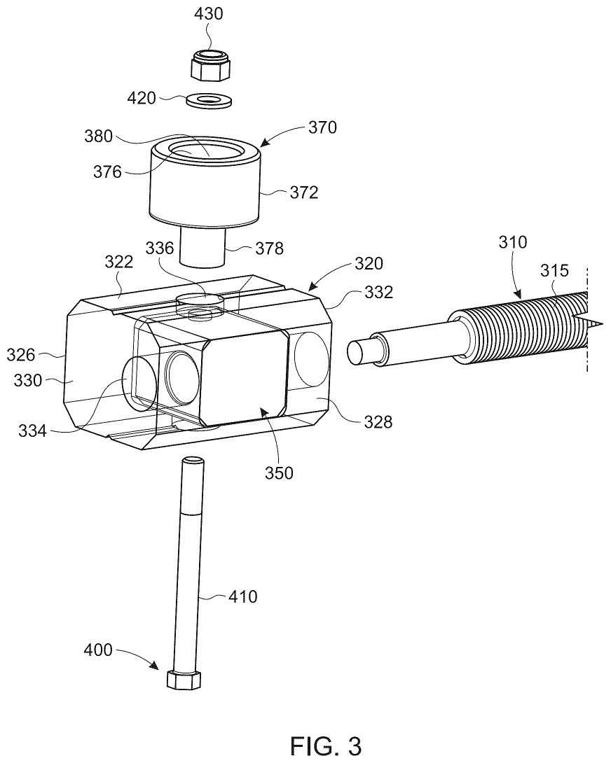

FIG. 4 is a fragmentary partially exploded and partially assembled perspective view of part of the puck assembly of the truss assembly table of FIG. 1.

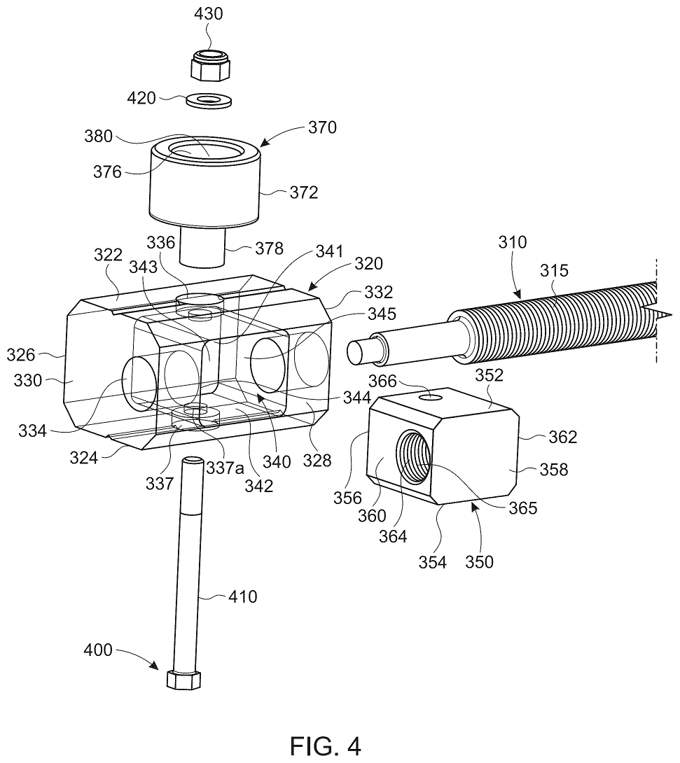

### DETAILED DESCRIPTION OF EXAMPLE EMBODIMENTS

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

The present disclosure relates to truss assembly tables and particularly provides a truss assembly table with multiple puck assemblies. Example embodiments of the truss assembly table including these puck assemblies of the present disclosure are discussed below; however, it should be appreciated that the present disclosure is not limited to the illustrated example truss assembly tables or the example puck assemblies.

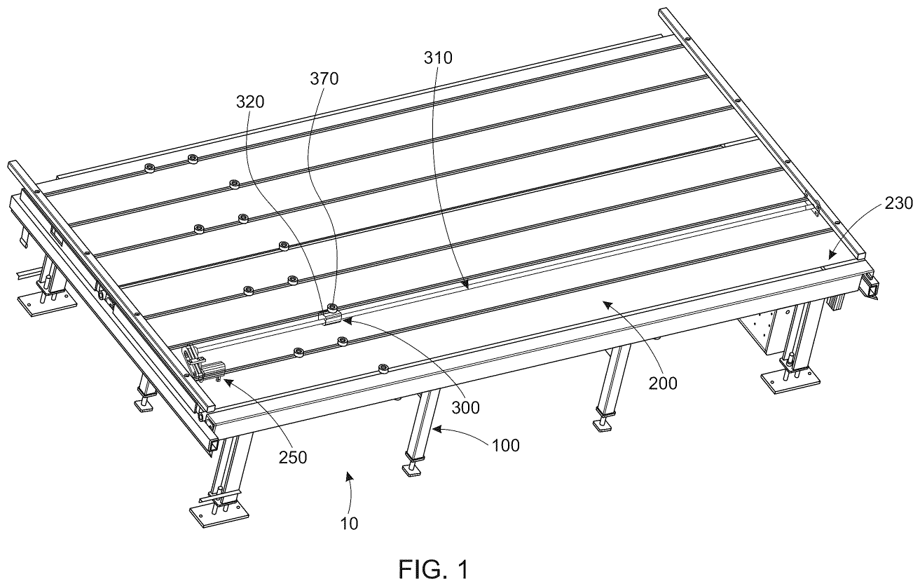

FIG. 1 shows a part of a truss assembly table 10 of one example embodiment of the present disclosure. This truss assembly table 10 generally includes among other components: (a) a table frame 100; (2) a table top 200; (3) multiple puck assemblies such as puck assembly 300; (4) a movable gantry (not shown); (5) a control system (not shown); (6) an operator interface (not shown); and (7) a power supply (not shown). For brevity, various components of the truss assembly table of the present disclosure are not shown or described herein because such components are well known in the truss assembly table industry.

This example truss assembly table 10 is configured for building trusses on the truss assembly table 10 in an end-to-end manner on the table top 200.

More specifically, the table frame 100 includes a plurality of frame components (not individually labeled) that are configured and attached in a suitable manner to support the other components of the truss assembly table 10. These frame components can take any suitable shape, can be formed is any suitable manner, and can be formed from any suitable materials. The table frame 100 has a longitudinal length that is longer than any truss to be built on the truss assembly table 10. The table frame 100 has a transverse width that has a width wider than any truss to be built on the truss assembly table 10.

The table top 200 is supported by the table frame 100, has a longitudinal length that is longer than any truss to be built on the truss assembly table 10, and has a transverse width that is wider than any truss to be built on the truss assembly table 10. The table top 200 includes one or more horizontally extending members (not labeled), wherein the upper most member includes an upper build surface 230 on which a truss being built on the truss assembly table 10 can rest. The table top 200 can be formed is any suitable manner and can be formed from any suitable materials.

In other embodiments, the truss assembly table 10 can be formed from multiple table frames and/or multiple table tops connected or positioned adjacent to each other.

In this example embodiment, the multiple puck assemblies are identical so only example puck assembly 300 is described herein for brevity. The puck assembly 300 includes: (1) a drive rod 310; (2) a mounting block 320; (3) a block insert 350; (4) a puck 370; and (5) a puck fastener assembly 400.

More specifically, the drive rod 310 extends transversely relative to the table top 200. The drive rod 310 is rotatable in opposite directions by a suitable drive assembly 250. The drive assembly 250 can be any suitable drive assembly. The drive rod 310 has an outer threaded surface 315.

The mounting block 320 includes: (1) an outer top surface 322; (2) an outer bottom surface 324; (3) an outer first side surface 326; (4) an outer second side surface 328; (5) an outer first end surface 330; and (6) an outer second end surface 332. The mounting block 320 includes angled outer connecting (such as chamfered) surfaces (not labeled) that respectively extend between and connect: (1) the outer top surface 322 and the outer first side surface 326; (2) the outer top surface 322 and the outer second side surface 328; (3) the outer bottom surface 324 and the outer first side surface 326; and (4) the outer bottom surface 324 and the outer second side surface 328. The mounting block 320 is formed from a rigid plastic material such as a nylon plastic filled with molybdenum disulfide lubricant powder (such as sold under the tradename Nylatron) in this example embodiment. The mounting block 320 can be formed in alternative configurations and with alternative materials in accordance with the present disclosure.

The mounting block 320 defines an inner cylindrical opening 334 longitudinally (and particularly horizontally) extending through the mounting block 320 from the outer first end surface 330 to the outer second end surface 332. The inner cylindrical opening 334 has two sections (not separately labeled) including a longitudinally extending inner first section extending inwardly from the outer first end surface 330 and a longitudinally extending inner second section extending inwardly from the outer second end surface 332. The inner first channel 334 is positioned, sized, shaped, and otherwise configured to receive the drive rod 310 such that the mounting block 320 is journaled about the drive rod 310. In this example embodiment, this is a smooth drilled oversize hole that is slightly larger than the maximum outer diameter of the threaded rod 310.

The mounting block 320 defines a cylindrical upper pocket 336 laterally (and particularly vertically) extending through part of the top portion of the mounting block 320 inwardly from the outer top surface 322. The upper pocket 336 is sized, shaped, and otherwise configured to receive part of the puck 370.

The mounting block 320 defines a cylindrical lower pocket 337 laterally (and particularly vertically) extending through part of the bottom portion of the mounting block 320 inwardly from the outer lower surface 324. The lower pocket 336 is sized, shaped, and otherwise configured to receive part of the head of the fastener 410 of the fastener assembly 400.

The mounting block 320 defines an inner second channel 336a laterally (and particularly vertically) extending through part of the top portion of the mounting block 320. The second channel 336a is sized, shaped, and configured to receive part of the shaft of the fastener 410 of the fastener assembly 400.

The mounting block 320 defines an inner second channel 376a laterally (and particularly vertically) extending through part of the bottom portion of the mounting block 320. The second channel 337a is also sized, shaped, and configured to receive part of the shaft of the fastener 410 of the fastener assembly 400.

The mounting block 320 defines an insert receipt area 340 that has an opening (not labeled) in the outer second side surface 328 of the mounting block 320. More specifically, the mounting block 320 includes: (1) an inner upper surface 341; (2) an inner lower surface 342; (3) an inner first side surface 343; (4) an inner first end surface 344; and (5) an inner second end surface 345, that define the insert receipt area 340. The insert receipt area 340 of the mounting block 320 is sized, shaped, and otherwise configured to receive the block insert 350.

The mounting block 320 also includes inner angled connecting (such as chamfered) surfaces (not labeled) respectively between: (1) the inner upper surface 341 and the inner first end surface 344; (2) the inner upper surface 341 and the inner second end surface 345; (3) the inner lower surface 342 and the inner first end surface 344; and (4) the inner lower surface 342 and the inner second end surface 345. These inner angled connecting surfaces also define the insert receipt area 340 that receives the block insert 350.

The block insert 350 includes: (1) an outer top surface 352; (2) an outer bottom surface 354; (3) an outer first side surface 356; (4) an outer second side surface 358; (5) an outer first end surface 360; and (6) an outer second end surface 362. The block insert 350 is made from bronze such as 932 bronze in this example embodiment. In various embodiments, the bronze can be a suitable oil impregnated bronze material or composite thereof.

The block insert 350 also includes angled outer connecting (such as chamfered) surfaces (not labeled) respectively between: (1) the outer top surface 352 and the outer first end surface 360; (2) the outer top surface 352 and the outer second end surface 362; (3) the outer bottom surface 354 and the outer first end surface 360; and (4) the outer bottom surface 354 and the outer second end surface 362.

The block insert 350 is thus sized, shaped, and otherwise configured to be securely positioned in the mounting block 320 and specifically in the insert receipt area 340 through the opening in the outer second side surface 328 of the mounting block 320. In such position, (1) the outer top surface 352 of the block insert 350 is configured to engage the inner upper surface 341 of the mounting block 320; (2) the outer bottom surface 354 of the block insert 350 is configured to engage the inner lower surface 342 of the mounting block 320; (3) the outer first side surface 356 of the block insert 350 is configured to engage the inner first side surface 343 of the mounting block 320; (4) the outer first end surface 360 of the block insert 350 is configured to engage the inner first end surface 344 of the mounting block 320; and (5) the outer second end surface 362 of the block insert 350 is configured to engage the inner second side surface 345 of the mounting block 320. Additionally, the respective outer angled surfaces (not labeled) of the block insert 350 are configured to engage the inner angled surfaces of the mounting block 320. These numerous different engagements of these respective surfaces prevent movement (such as any rotation) of the block insert 350 within the insert receipt area 340 of the block insert 350. The block insert 350 can be press fit into the mounting block 320 and the fastener assembly 400 additionally secures the block insert 350 in the mounting block 320.

The block insert 350 defines a first channel 364 extending through the block insert 350 from the first end surface 360 to the second end surface 362. The first channel 364 is sized, shaped, and otherwise configured to receive the threaded drive rod 310 such that the block insert 350 is journaled about the drive rod 310. The block insert 350 includes inner threads 365 on the interior wall that defines the first channel 364. This first channel 364 is offset from the center of the block insert 350 toward the outer second side surface 358 of the block insert 350 such that the engagement between the block insert 350 and the drive rod 310 is offset from the shaft of bolt 410 of the fastener assembly 400 that extends though the block insert 350 as described below.

The block insert 350 is bronze and defines tight tolerances between the outer threads 315 of the drive rod 310 and the inner threads 365 of the block insert 350 to limit the build-up of dust and other debris between the block insert 350 and the drive rod 310. This solves the above-described problems regarding dust and other debris build-up between the mounting block and the drive rod in previously employed puck assemblies for truss assembly tables. This also enable the motor that rotates the drive rod 310 to operate in a smoother manner.

The block insert 350 also defines a second channel 366 extending laterally (and particularly vertically) through the block insert 350 from the top surface 352 to the bottom surface 354. The second channel 366 is sized, shaped, and otherwise configured to receive part of the shaft of the fastener 410 of the fastener assembly 400.

The puck 370 includes an upper cylindrical head 372 and a lower cylindrical neck 378 fixedly connected to and extending downwardly from the head 372 of the puck 370.

The head 372 and the neck 378 define a cylindrical center channel 380 sized, shaped, and otherwise configured to receive part of the shaft of the fastener 410 of the fastener assembly 400.

The head 372 also defines a cylindrical lateral securement member receiving area 376 sized, shaped, and otherwise configured to receive part a mounting washer 420 and a mounting nut 430 attached to the shaft of the fastener 410 of the fastener assembly 400.

The head 372 is also sized, shaped, and otherwise configured to engage a part of a truss being built on the table top 100.

The neck 378 is shaped, sized, and otherwise configured to extend through the table top 100 to the top of the mounting block 320 and into the cylindrical upper pocket 336 of the mounting block 320.

The puck fastener assembly 400 includes the mounting bolt 410, the mounting washer 420, and the mounting nut 430, but can be otherwise suitably configured in accordance with the present disclosure. Thus, the puck fastener assembly 400 is configured to extend through the puck 370, the mounting block 320, and the insert block 350 to secure these components together. It should be noted that the mounting bolt 410 extends through the channels defined by the mounting block 320 and the insert block 350 as described above and that those channels are offset from the center of those respective components such as not to interfere with the engagement between the block insert 350 and the drive rod 310.

The gantry (not shown) includes any suitable gantry that is longitudinally moveable relative to the table top 100 and configured to secure attachment plates to the chord members and web members in a conventional manner or in a manner to be developed in the future.

In various embodiments, the control system (not shown) includes one or more manually controlled switching mechanisms.

In various embodiments, the control system includes one or more PLC boards or is integrated into one or more PLC boards.

In various embodiments, the control system includes one or more processing devices communicatively connected to one or more memory devices.

In various embodiments, the control system includes a programmable logic control system. The processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine.

In various embodiments, the control system include one or more memory devices. Each memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. Each memory device stores instructions executable by the processing device to control operation of the truss assembly table 10.

In various embodiments, the control system is communicatively and operably connected to the actuators including the servo motors, sensors, the operator interface, and the power supply, and configured to receive signals from and send signals to those components.

In various embodiments, the control system is communicatively connectable (such as via Wi-Fi, Bluetooth, near-field communication, or other suitable wireless communications protocol) to an external device, such as a computing device, to send information to and receive information from that external device.

The operator interface can include a suitable display screen with a touch panel. In such embodiments with a display screen, the display screen is configured to display information regarding the truss assembly table 10, and the touch screen is configured to receive operator inputs. The operator interface is communicatively connected to the control system to send signals to the control system and to receive signals from the control system. Other embodiments of the truss assembly table 10 do not include a touch panel. Still other embodiments of the truss assembly table 10 do not include a display assembly. Certain embodiments of the truss assembly table 10 include a separate pushbutton panel instead of a touch panel beneath or integrated with the display screen. In certain embodiments of the truss assembly table 10, the operator interface includes one or more pushbuttons (and associated light) and no display screen or touch panel.

In various embodiments, the power supply is electrically connected to (via suitable wiring and other components) and configured to power several components of the truss assembly table 10. In various embodiments, the power supply can include a pneumatic air power supply.

It will be understood that modifications and variations may be affected without departing from the scope of the novel concepts of the present invention, and it is understood that this application is to be limited only by the scope of the claims.

1. A truss assembly table comprising:
a table frame;
a table top supported by the table frame; and
a plurality of puck assemblies supported by the table frame, each puck assembly including:
a drive rod having outer threads,
a mounting block,
a block insert positioned in the mounting block, the block defining an inner first channel extending through the block insert from a first end surface to a second end surface, the inner first channel configured to receive the threaded drive rod such that the block insert is journaled about the drive rod, the block insert including inner threads mated with the outer threads of the drive rod,
a puck, and
a fastener assembly connecting the puck, the mounting block, and the block insert.

2. The truss assembly table of claim 1, wherein the mounting block is plastic and the block insert is bronze.

3. The truss assembly table of claim 1, wherein the mounting block defines an insert receipt area that has an opening in an outer second side surface of the mounting block and that is configured to receive the block insert.

4. The truss assembly table of claim 1, wherein the mounting block includes inner surfaces that are configured to engage outer surfaces of the block insert and that prevent movement of the block insert in the mounting block.

5. The truss assembly table of claim 1, wherein the mounting block defines:
an inner first channel longitudinally extending through the mounting block from an outer first end surface to an outer second end surface, wherein the inner first channel configured to receive the drive rod such that the mounting block is journaled about the drive rod, and
an offset from center second channel laterally extending through part of a top portion of the mounting block and part of a bottom portion of the mounting block, the second channel configured to receive part of the fastener assembly.

6. The truss assembly table of claim 1, wherein the inner first channel of the block insert is offset from a center of the block insert toward an outer second side surface of the block insert such that the engagement between the block insert and the drive rod is offset from the fastener assembly.

7. The truss assembly table of claim 1, wherein the block insert defines a laterally extending inner second channel that is offset from a center of the block insert toward an outer first side surface of the block insert and configured to receive part of the fastener assembly such that the engagement between the block insert and the drive rod is offset from the fastener assembly.

8. A truss assembly table puck assembly comprising:
a mounting block;
a block insert positionable in the mounting block, the block defining an inner first channel extending through the block insert from a first end surface to a second end surface, the inner first channel configured to receive a threaded drive rod such that the block insert is journaled about the drive rod, the block insert including inner threads configured to mate with the outer threads of the drive rod;
a puck; and
a fastener assembly configured to connect the puck, the mounting block, and the block insert.

9. The truss assembly table puck assembly of claim 8, wherein the mounting block is plastic and the block insert is bronze.

10. The truss assembly table puck assembly of claim 8, wherein the mounting block defines an insert receipt area that has an opening in an outer second side surface of the mounting block and that is configured to receive the block insert.

11. The truss assembly table puck assembly of claim 8, wherein the mounting block includes inner surfaces that are configured to engage outer surfaces of the block insert and that prevent movement of the block insert in the mounting block.

12. The truss assembly table puck assembly of claim 8, wherein the mounting block defines:
an inner first channel longitudinally extending through the mounting block from an outer first end surface to an outer second end surface, wherein the inner first channel configured to receive the drive rod such that the mounting block is journaled about the drive rod, and
an offset from center second channel laterally extending through part of a top portion of the mounting block and part of a bottom portion of the mounting block, the second channel configured to receive part of the fastener assembly.

13. The truss assembly table puck assembly of claim 8, wherein the inner first channel of the block insert is offset from a center of the block insert toward an outer second side surface of the block insert such that the engagement between the block insert and the drive rod is offset from the fastener assembly.

14. The truss assembly table puck assembly of claim 8, wherein the block insert defines a laterally extending inner second channel that is offset from a center of the block insert toward an outer first side surface of the block insert and configured to receive part of the fastener assembly such that the engagement between the block insert and the drive rod is offset from the fastener assembly.
